(19) United States
(12) Patent Application Publication
(10) Pub. No.: US 2011/0032422 A1
(43) Pub. Date: Feb. 10, 2011

(54) VIDEO PROCESSING SYSTEM

(75) Inventors: Nariaki YAMAMOTO, Hyogo (JP); Shun KINOSHITA, Osaka (JP); Hiroshi TANIUCHI, Hyogo (JP); Kunihiro KAIDA, Osaka (JP); Kazuyuki ISHIDA, Osaka (JP)

Correspondence Address: McDERMOTT WILL & EMERY LLP, 600 13th Street, N.W., Washington, DC, 20005-3096, US

(73) Assignee: PANASONIC CORPORATION, Osaka (JP)

(21) Appl. No.: 12/906,705

(22) Filed: Oct. 18, 2010

Related U.S. Application Data
(63) Continuation of application No. PCT/JP2009/002257, filed on May 21, 2009.

(30) Foreign Application Priority Data
Jun. 5, 2008 (JP) 2008-147900

(51) Int. Cl. H04N 5/04

(52) U.S. Cl. 348/500; 348/E05.009

(57) ABSTRACT

In a video processing system which divides HD-size image data into a plurality pieces of sub-image data and performs image processing for upconversion to 4K×2K image data, four image processors synchronous with an HD signal each process a corresponding one of the four pieces of sub-image data. In this case, the image processors process the four pieces of sub-image regions while causing the four pieces of sub-image regions to overlap at their division boundaries, and particularly process the overlapping regions during respective blanking periods. After the image processing of the image processors, the overlapping data is removed. Thereafter, the pieces of image data of the four sub-regions are combined. Therefore, the division boundaries of the pieces of sub-images can be processed without a degradation in image quality.

### CROSS-REFERENCE TO RELATED APPLICATIONS

This is a continuation of PCT International Application PCT/JP2009/002257 filed on May 21, 2009, which claims priority to Japanese Patent Application No. 2008−147900 filed on Jun. 5, 2008. The disclosures of these applications including the specifications, the drawings, and the claims are hereby incorporated by reference in their entirety.

### BACKGROUND

The present disclosure relates to video processing systems which perform image processing with respect to a divided image and output the resultant image.

The resolution of video data has been increased to the high definition (HD) resolution, leading to the penetration of Blu-ray discs, the commencement of digital broadcasting, and the like. This has been accompanied by the development of display devices (plasma panels, liquid crystal panels, projectors, etc.) having higher resolutions. HD-resolution display devices are becoming popular. The resolution as well as the display screen size of display devices are still increasing. Panels having the 4K×2K resolution which is four times as high as the HD resolution have been developed. It is more than likely that an image processing technique of upconverting HD to 4K×2K will be required in order to display HD video sources (video data of Blu-ray, digital broadcasting, and the like) on display devices having a higher resolution (4K×2K resolution).

In conventional HD processing systems, when images having the 4K×2K size are processed, a clock (CLK) frequency may be caused to be four times as high in order to improve the processing performance. To achieve this, the microfabrication process and the high-speed transmission interface need to be enhanced, which is not a practical solution.

Therefore, in the conventional art, images having a super resolution (e.g., the 4K×2K resolution) may be processed using a configuration shown in FIG. 11. Note that such a conventional 4K×2K image processing system is described in, for example, Japanese Patent Publication No. 2007−108447.

In FIG. 11, the system includes four image processors 1105-1108 each of which is capable of processing HD-size images. The system divides input image data into four pieces of sub-image data (sub-video), which are processed by the image processors 1105-1108. Pseudo-pixel inserters 1101-1104 are provided in a preceding stage from the image processors 1105-1108. Image trimmers 1109-1112 are provided in a succeeding stage from the image processors 1105-1108.

The pseudo-pixel inserters 1101-1104 each perform a process of inserting pseudo-pixels which are calculated from the sub-video into a region outside an effective pixel region at a division boundary of the image data. Thereafter, the image processors 1105-1108 perform processing. As a result, the division boundary can be subjected to a spatially continuous process using the pseudo-pixels instead of an end process. The image trimmers 1109-1112 in the succeeding stage remove the pseudo-pixel data regions which have been inserted by the pseudo-pixel inserters 1101-1104 in the preceding stage.

With the aforementioned configuration, a technique of reducing the disturbance of an image at the division boundary when the sub-images are recombined has been devised in conventional super-resolution image processing systems.

### SUMMARY

However, in the division boundary process of the aforementioned configuration, the pseudo-pixels generated from the effective pixel region are used, and in some pseudo-pixel generating manners, the image disturbance occurs at the division boundary after processing by the image processors in the succeeding stage as in the case where pseudo-pixels are not generated, which is a problem.

In view of the aforementioned problems, the present disclosure has been made. The detailed description describes implementations of a video processing system which divides video data into pieces of sub-video data and performs image processing with respect to the sub-video data, and in which a degradation in an image at a division boundary is reduced or prevented, thereby providing higher image quality.

In the present disclosure, when N image processors each of which is capable of processing high definition (HD)-size video and is synchronous with an HD synchronization signal are provided, image processing is performed with respect to sub-video data of each of a plurality of sub-regions obtained by dividing the HD-size image while adjacent sub-regions overlap at their boundary.

Specifically, an example video processing system of the present disclosure includes N (N is an integer of two or more) image processors each configured to be capable of processing high definition (HD)-size video and be synchronous with an HD synchronization signal, a region division calculator configured to control data transfer regions of the N image processors, and an image processing mode controller configured to control image processing modes of the N image processors. The N image processors process N respective pieces of sub-video data obtained by dividing video data, and the processed N pieces of sub-video data are combined in a succeeding stage from the N image processors.

In the example video processing system of the present disclosure, each of the N image processors may include an overlapping region calculator configured to calculate an overlapping region at an image boundary between adjacent regions of the N pieces of sub-video data obtained by the region division calculator, an active period generator configured to generate an active period of video data based on the result of the calculation of the overlapping region calculator, a data request generator configured to request data transfer corresponding to the active period, a resizing processor configured to resize boundary video data, an image quality improving image quality adjuster configured so that a mode thereof is set by the image processing mode controller, and an image trimmer configured to remove data of the overlapping region.

Thus, in the present disclosure, the pieces of sub-video data to be processed overlap at the image boundary, whereby it is possible to reduce or prevent disturbance which occurs at the image boundary when image combination in a succeeding stage is performed at the region boundary using an end process.

In the example video processing system of the present disclosure, the N image processors may perform image processing with respect to the overlapping region during a blanking period of the HD synchronization signal.

Thus, in the present disclosure, image processing is performed with respect to the overlapping region during the blanking period of the HD synchronization signal, whereby an increase in the load of image processing corresponding to the overlapping region can be reduced or prevented.

In the example video processing system of the present disclosure, the image quality improving image quality adjuster may have a mechanism configured to store a cumulative value of feature amounts or motion detection results of video. Cumulative values of the sub-images may be integrated and judged by the image processing mode controller, and the result of the judgment may be used to set the mode of the image quality improving image quality adjuster again.

Thus, in the present disclosure, the sub-images can be processed in the same image processing mode.

In the example video processing system of the present disclosure, each of the N image processors may include a combiner configured to combine a plurality of image planes. The region division calculator may calculate division coordinates and size information of combination screens from screen combination coordinates, and set the result of the calculation into the data request generators of the N image processors so that screen combination is performed with respect to the N pieces of sub-video data.

Thus, in the present disclosure, multiple-screen combination, such as Picture in Picture (PIP) and the like, and on-screen display (OSD) superimposition can be achieved.

Another example video processing system of the present disclosure includes N (N is an integer of two or more) image processors each configured to be capable of processing high definition (HD)-size video and be synchronous with an HD synchronization signal, and an image processing mode controller configured to control image processing modes of the N image processors. The N image processors process the same video data. The image processing mode controller sets different image processing modes into the N image processors. N screens are combined after image processing of the N image processors.

Thus, in the present disclosure, the same image is processed in N different image processing modes and the resultant N images are combined into a single screen, which is then displayed, whereby the image processing modes can be compared.

Another example video processing system of the present disclosure includes N (N is an integer of two or more) image processors each configured to be capable of processing high definition (HD)-size video and be synchronous with an HD synchronization signal. Operating clocks of the N image processors can be separately stopped.

Thus, in the present disclosure, by stopping the operating clocks for (N−1) image processors when HD-size data is output without changing the size, power consumption can be reduced.

As described above, according to the present disclosure, when N HD-size image processors are used to perform image processing with respect to input N pieces of sub-image data, and the processed N pieces of sub-image data are combined into 4K×2K-size image data, it is possible to reduce or prevent disturbance at the image boundary.

Moreover, according to the present disclosure, in imaging processing for conversion to 4K×2K, the same image is processed in N different image processing modes, and the resultant N images are combined into a single screen, whereby the image processing modes can be compared.

Moreover, according to the present disclosure, even when N HD-size image processors are provided to perform image processing for conversion to 4K×2K, HD-size data may be output without changing the size. In this case, power consumption can be reduced by stopping operating clocks for (N−1) image processors.

### BRIEF DESCRIPTION OF THE DRAWINGS

FIG. 1 is a diagram showing a video processing system according to a first embodiment of the present disclosure.

FIG. 2 is a diagram showing a configuration of an image processor included in the video processing system of FIG. 1.

FIG. 3 is a diagram showing a process of dividing video data in the video processing system of FIG. 1.

FIG. 4 is a timing chart of the image processor of FIG. 2.

FIG. 5 is a diagram showing a video processing system according to a second embodiment of the present disclosure.

FIG. 6 is a diagram showing a configuration of an image processor included in the video processing system of FIG. 5.

FIG. 7 is a diagram showing a process of dividing video data in the video processing system of FIG. 5.

FIG. 8 is a diagram showing a video processing system according to a third embodiment of the present disclosure.

FIG. 9 is a diagram showing a configuration of an image processing mode controller included in the video processing system of FIG. 8.

FIG. 10 is a diagram showing a video processing system according to a fourth embodiment of the present disclosure.

FIG. 11 is a diagram showing a conventional video processing system.

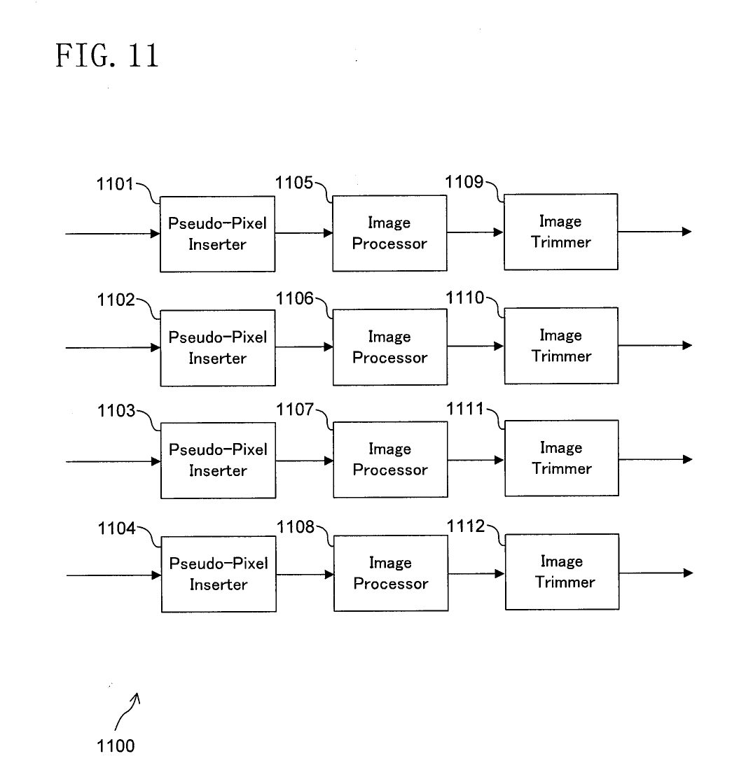

### DETAILED DESCRIPTION

Embodiments of the present disclosure will be described with reference to the accompanying drawings.

### First Embodiment

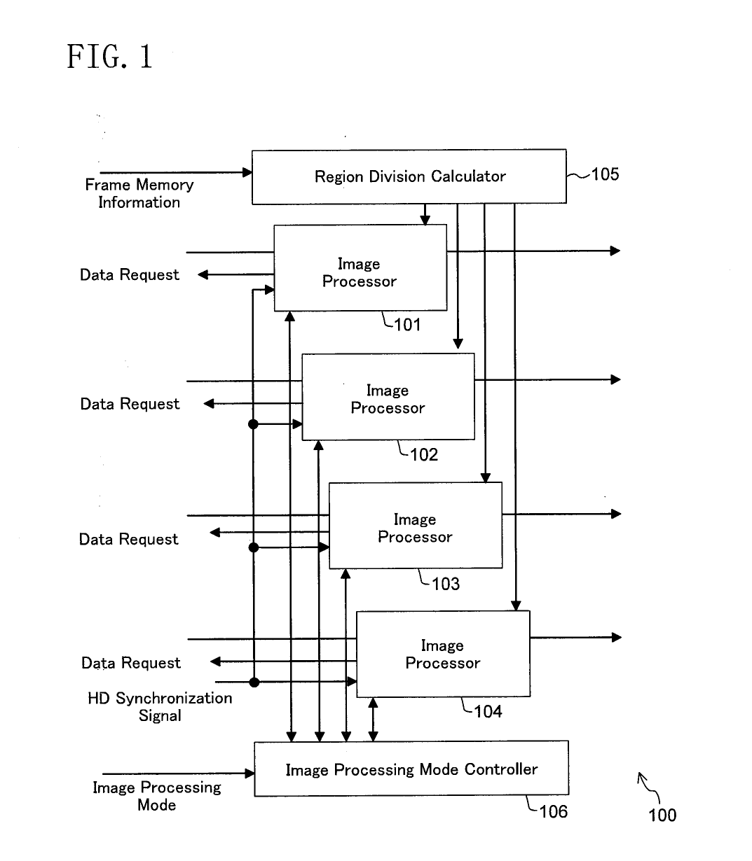

A first embodiment of the present disclosure will be described hereinafter with reference to FIGS. 1-4.

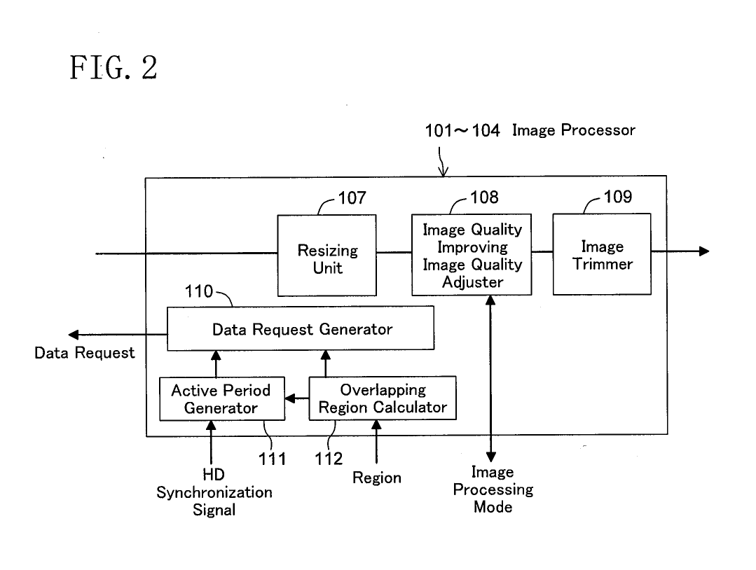

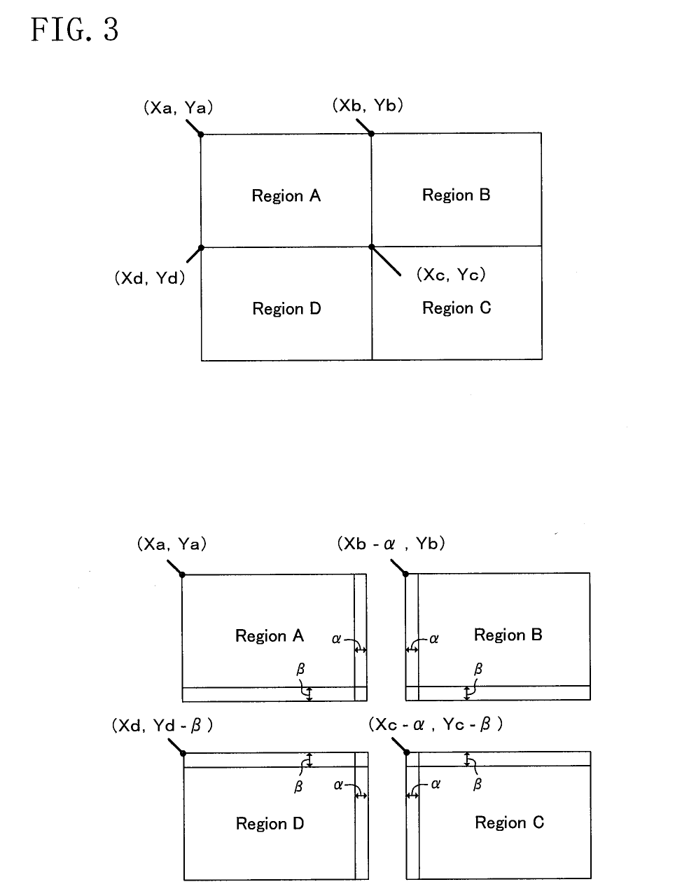

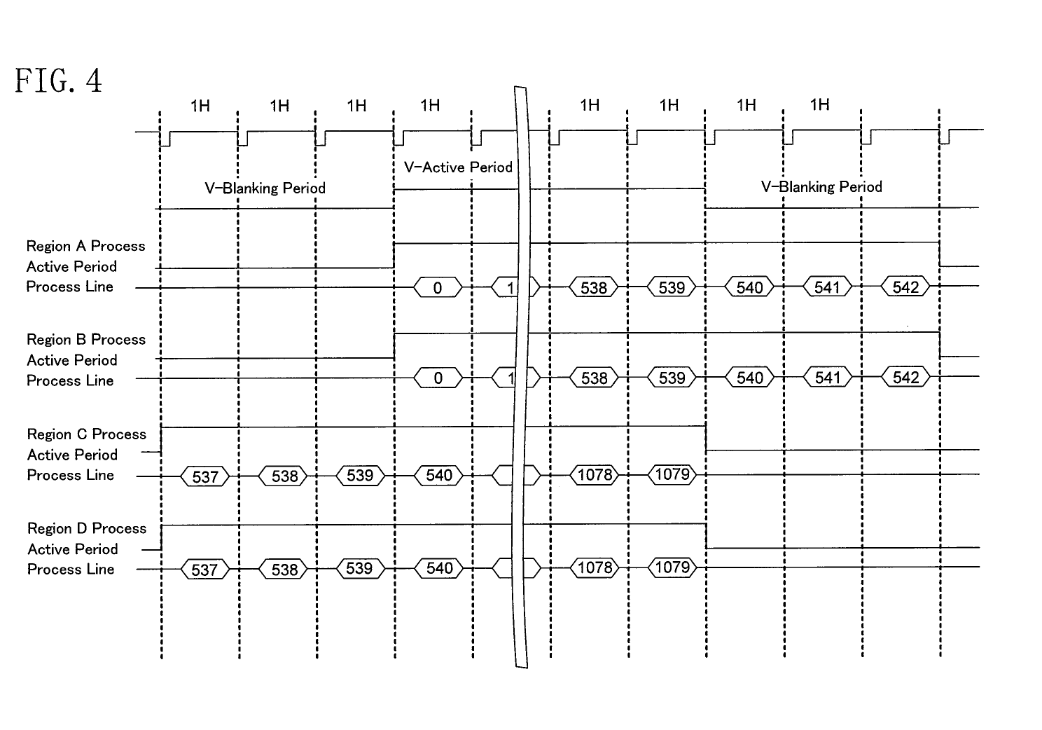

FIGS. 1 and 2 are diagrams showing a configuration of a video processing system according to the first embodiment of the present disclosure. FIG. 3 is a diagram showing the manner in which an image is divided in the first embodiment. FIG. 4 is a timing chart of the video processing system of the first embodiment of the present disclosure. Firstly, the configuration of the video processing system 100 of the first embodiment which increases the resolution of high-definition (HD) image data into the 4K×2K resolution will be described with reference to FIG. 1. In the first embodiment, the video processing system 100 includes four image processors 101-104 each of which is capable of processing HD-size video and is synchronous with an HD synchronization signal, a region division calculator 105 which controls data transfer regions of the four image processors 101-104, and an image processing mode controller 106 which controls image processing modes of the image processors 101-104.

A configuration of each of the image processors 101-104 of the first embodiment will be described with reference to FIG. 2. The image processors 101-104 each include an overlapping region calculator 112 which calculates an overlapping region at a boundary of each adjacent two of four sub-images obtained from the region division calculator 105, an active period generator 111 which generates a process active period of the image processor based on the overlapping regions calculated by the overlapping region calculator 112, a data request generator 110 which requests data transfer corresponding to the active period, a resizing unit (resizing processor) 107 which resizes boundary video data, an image quality improving image quality adjuster 108 whose mode is set by the image processing mode controller 106, and an image trimmer 109 which removes the overlapping region data.

Operation of the video processing system thus configured will be described hereinafter. It is assumed that decoded video data from digital broadcasting, an HD-compliant disk, or the like is stored in an external memory, such as a dynamic random access memory (DRAM) or the like. A position of the video data in the external memory is set into the region division calculator 105. In order to transfer four pieces of sub-video data to the respective corresponding image processors 101-104, positions of the four pieces of sub-video data are set into the respective corresponding image processors 101-104. In this case, an image having the HD size (1920×1080) is divided into four regions (A, B, C, and D) each having the QHD size (960×540).

The division of an image into four regions will be described with reference to FIG. 3. Here, the upper left region is referred to as a region A, the upper right region is referred to as a region B, the lower right region is referred to as a region C, and the lower left region is referred to as a region D. The transfer start position of each region is defined as follows: (Xa, Ya)=(0, 0) for the region A, (Xb, Yb)=(960, 0) for the region B, (Xc, Yc)=(960, 540) for the region C, and (Xd, Yd)=(0, 540) for the region D. The image processor 101 processes the region A. The image processor 102 processes the region B. The image processor 103 processes the region C. The image processor 104 processes the region D. When receiving the division data position, each image processor receives a data position, and performs calculation using the overlapping region calculator 112, taking into consideration overlapping regions (α pixels, β lines) flanking division boundaries, sets a data transfer size and a position corresponding to the result of the calculation into the data request generator 110, and sets an image processing size into the resizing unit 107 and the image quality improving image quality adjuster 108. Here, α and β are determined, depending on at least the number of taps in a process in the horizontal or vertical direction in the resizing unit 107 and the image quality improving image quality adjuster 108 of each image processor.

In the case of the image processor 101 for the region A, the division data position (Xa, Ya) and the data transfer size ((960+α) pixels, (540+β) lines) are set into the data request generator 110, the resizing unit 107, and the image quality improving image quality adjuster 108. Similarly, in the case of the image processor 102 for the region B, the division data position (Xb−α, Yb) and the data transfer size ((960+α) pixels, (540+β) lines) are set. In the case of the image processor 103 for the region C, the division data position (Xc−α, Yc−β) and the data transfer size ((960+α) pixels, (540+β) lines) are set. In the case of the image processor 104 for the region D, the division data position (Xd, Yd−β) and the data transfer size ((960+α) pixels, (540+β) lines) are set.

The active period generator 111 which generates a process active period of the image processor receives information about the overlapping region from the overlapping region calculator 112 to generate an active period for the corresponding image processing region.

FIG. 4 is a timing chart showing a relationship between the process active periods of the image processors 101-104 and processing lines in the vertical direction. For the regions A and B are extended so that lower regions thereof overlap the regions D and C, respectively, by β lines, and the resultant regions A and B are subjected to image processing. In this case, the image processing of the overlapping lower regions is performed during a lower vertical blanking period of an HD vertical synchronization signal. The regions C and D are extended so that upper regions thereof overlap the regions B and A, respectively, by β lines, and the resultant regions C and D are subjected to image processing. In this case, the image processing of the overlapping upper regions is performed during an upper vertical blanking period of the HD vertical synchronization signal. Also in the case of the horizontal direction, image processing is performed with respect to pixels including overlapping regions in the horizontal direction during blanking periods of an HD horizontal synchronization signal.

The resizing unit 107 enlarges an image of ((960+α) pixels, (540+β) lines) to an image of (2×(960+α) pixels, 2×(540+β) lines). Thereafter, the image quality improving image quality adjuster 108 whose mode has been set by the image processing mode controller 106 performs image quality improving image processing with respect to the image containing the overlapping regions. Thereafter, the image trimmer 109 trims the image into an image having the HD size (1920×1080). In this case, lines and pixels removed by the trimming are those during vertical and horizontal blanking periods. Thereafter, the pieces of data of the four regions having the HD size enlarged by the image processors 101-104 in similar manners are combined into video having the 4K×2K size after the processing of the video processing system. In this case, the boundaries of the four regions are subjected to image processing using the overlapping regions without performing an end process, i.e., continuous video data is used. As a result, disturbance does not occur at the boundaries when the four regions are combined.

The image quality improving image quality adjuster 108 may include a mechanism which stores a cumulative value of feature amounts or motion detection results of video, and an image quality adjusting mechanism (not shown) which determines an image processing mode based on the cumulative value. In this case, the image processing mode controller 106 integrates and judges the cumulative values of the four sub-images, and sets a mode in the image quality improving image quality adjusters 108 again. As a result, the sub-images can be processed in the same image processing mode. Therefore, it is possible to avoid the situation that pieces of sub-video are processed in different image processing modes and combined into an unnatural image.

With the aforementioned configuration of the first embodiment, when video data is divided, overlapping regions corresponding to the number of taps in image processing are processed during blanking periods of HD horizontal and vertical synchronization signals. As a result, the resizing process and the image quality improving process can be performed with respect to division boundaries without performing an end process. Thereafter, only data corresponding to the active period is output. As a result, even when a single piece of video data is divided into pieces of sub-video data which are then processed by the separate image processors 101-104 before being combined, disturbance advantageously does not occur at the boundaries.

The image quality improving image quality adjuster 108 has the mechanism which stores a cumulative value of feature amounts or motion detection results of video. The image processing mode controller 106 integrates and judges the cumulative values of the sub-images, and sets a mode in the image quality improving image quality adjusters 108 again. As a result, the sub-images can be processed in the same image processing mode. Therefore, it is possible to avoid the situation that pieces of sub-video are processed in different image processing modes and combined into an unnatural image.

The size of the decoded video data in the external memory in the first embodiment may be that of an interlaced material (1920×540), the SD size, or 4K×2K in addition to the HD size (1920×1080).

In the image processors 101-104 of the first embodiment, the order in which the resizing unit 107 and the image quality improving image quality adjuster 108 are arranged on the data path may be reversed.

While, in the first embodiment, video data is divided into four pieces and four image processors are provided, the present disclosure is not limited to four. The present disclosure may provide a system in which video data is divided into N pieces (N is an integer of two or more) and N image processors are provided.

### Second Embodiment

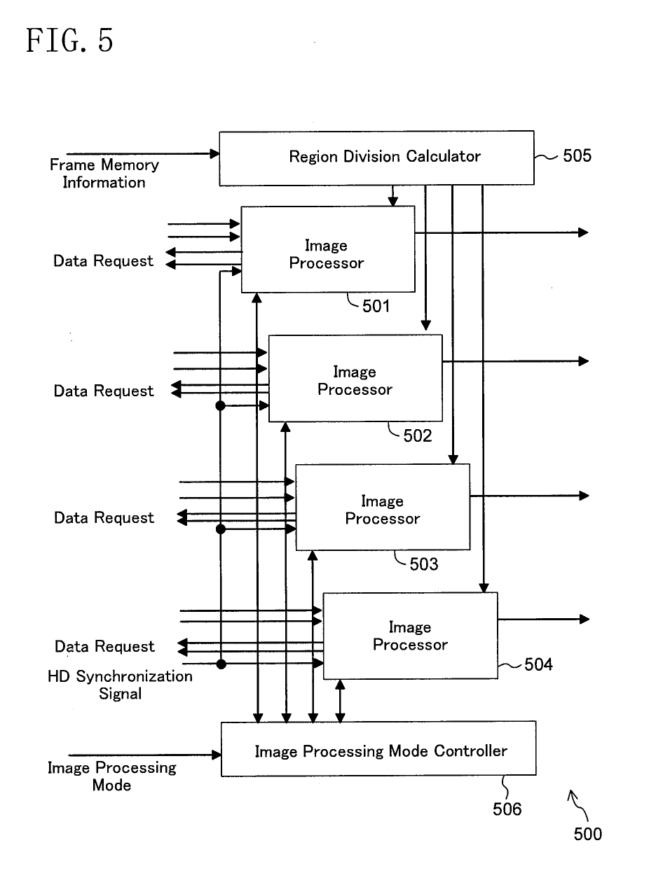

Next, a second embodiment of the present disclosure will be described with reference to FIGS. 5-7.

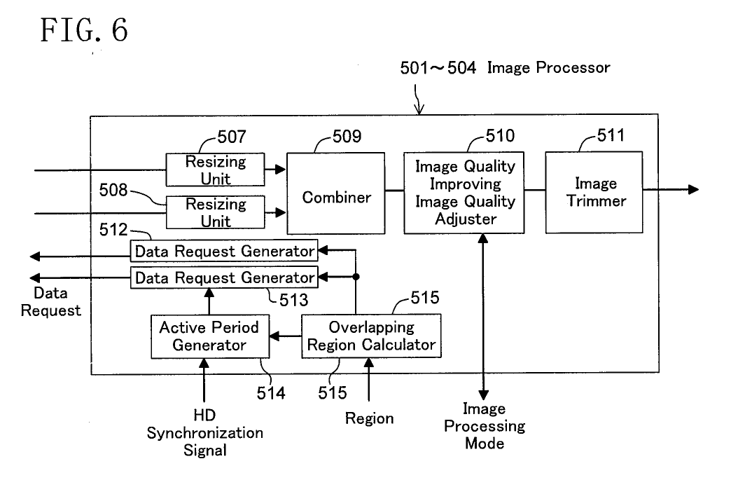

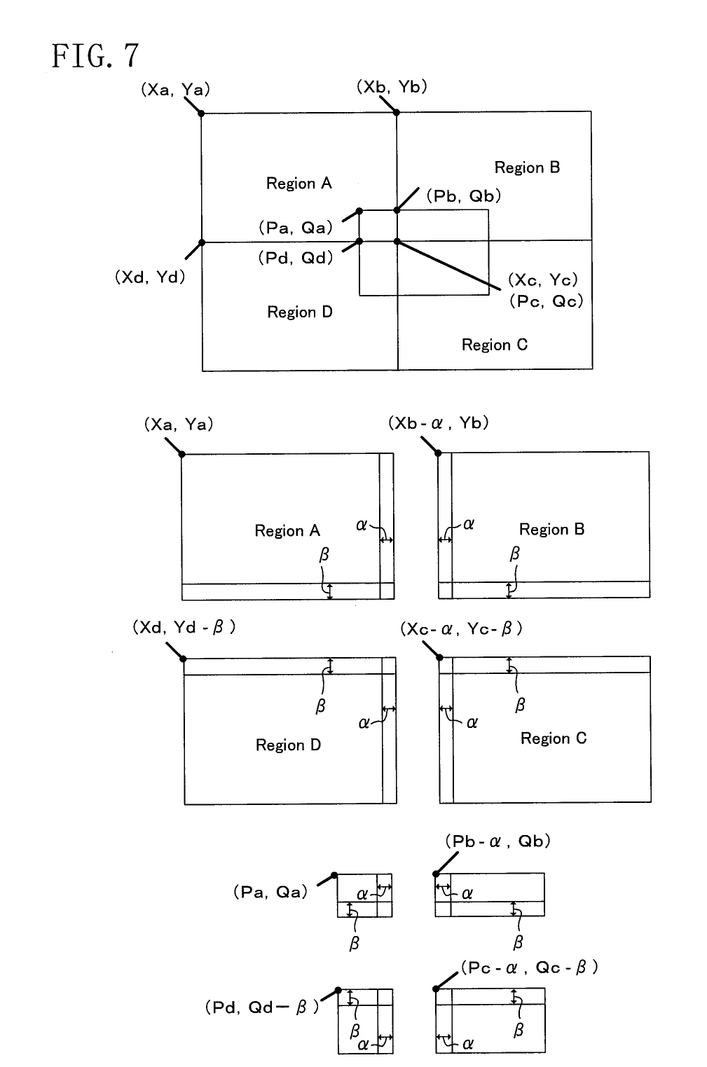

FIGS. 5 and 6 are diagrams showing a configuration of a video processing system according to the second embodiment of the present disclosure. FIG. 7 is a diagram showing the manner in which an image is divided in the second embodiment.

Firstly, the configuration of the video processing system 500 of the second embodiment which increases the resolution of video in which image data having the standard definition (SD) resolution is displayed in image data having the high definition (HD) resolution (Picture in Picture (PIP)) to the 4K×2K resolution, will be described with reference to FIG. 5.

In the second embodiment, the video processing system 500 includes four image processors 501-504 each of which is capable of processing HD-size video and is synchronous with an HD synchronization signal, a region division calculator 505 which controls data transfer regions of the four image processors 501-504, and an image processing mode controller 506 which controls image processing modes of the image processors 501-504.

A configuration of each of the image processors 501-504 of the second embodiment will be described with reference to FIG. 6. The image processors 501-504 each include an overlapping region calculator 515 which calculates an overlapping region at a boundary of each adjacent two of four sub-images obtained from the region division calculator 505, an active period generator 514 which generates a process active period of the image processor based on the overlapping regions calculated by the overlapping region calculator 515, two data request generators 512 and 513 which request data transfer corresponding to the active period, two resizing units 507 and 508 which resize boundary video data, a combiner 509 which can combine a plurality of image planes, an image quality improving image quality adjuster 510 whose mode is set by the image processing mode controller 506, and an image trimmer 511 which removes the overlapping region data.

Operation of the video processing system thus configured will be described hereinafter. It is assumed that a piece of decoded video data having the HD size and a piece of decoded video data having the SD size from digital broadcasting, an HD-compliant disk, or the like are stored in an external memory, such as a dynamic random access memory (DRAM) or the like. In this case, the video having the SD size is eventually displayed as a PIP, where the base point of the video having the SD size is a position (i, j) of the video having the HD size.

The positions of the pieces of video data in the external memory are set into the region division calculator 505. The division data positions are set into the respective corresponding image processors 501-504 in order to transfer the four pieces of sub-video data to the respective corresponding image processors 501-504. In this case, as shown in FIG. 7, the image having the HD size (1920×1080) is divided into four regions (A, B, C, and D) having the QHD size (960×540). Here, the upper left region is referred to as a region A, the upper right region is referred to as a region B, the lower right region is referred to as a region C, and the lower left region is referred to as a region D. The transfer start position of each region is defined as follows: (Xa, Ya)=(0, 0) for the region A, (Xb, Yb)=(960, 0) for the region B, (Xc, Yc)=(960, 540) for the region C, and (Xd, Yd)=(0, 540) for the region D. The image processor 501 processes the region A. The image processor 502 processes the region B. The image processor 503 processes the region C. The image processor 504 processes the region D.

The manner in which the image having the SD size (720×480) is divided and transferred to the image processors 501-504 is calculated by the region division calculator 505 based on a screen combination position and a combination screen size.

1) When (i, j) is located in the region A, (i+720, j) is located in the region B, and (i, j+480) is located in the region D, i.e., ((960−720)≦i≦960 and (540−480)≦j≦540), the SD-size image has the following transfer start positions:

(Pa, Qa)=(0, 0)

(Pb, Qb)=(960−i, 0)

(Pc, Qc)=(960−i, 540−j)

(Pd, Qd)=(0, 540−j)

The transfer image sizes are:

(960−i)×(540−j) for SDa

(720−(960−i))×(540−j) for SDb

(720−(960−i))×(480−(540−j)) for SDc

(960−i)×(480−(540−j)) for SDd

The screen combination positions of the sub-screens in the regions A, B, C, and D are:

(ia, ja)=(i, j)

(ib, jb)=(0, j)

(ic, jc)=(0, 0)

(id, jd)=(i, 0)

2) When (i, j) is located in the region A, (i+720, j) is located in the region A, (i, j+480) is located in the region D, i.e., (i≦(960−720), (540−480)<j<540), the regions B and C are not involved with screen combination. Therefore, SD-size sub-screens corresponding to the image processors 502 and 503 are not transferred. The transfer start positions of the SD-size sub-screens transferred to the regions A and D are:

(Pa, Qa)=(0, 0)

(Pd, Qd)=(0, 540−j)

The transfer image sizes are:

720×(540−j) for SDa

720×(480−(540−j)) for SDd

The screen combination positions of the sub-screens in the regions A and D are:

(ia, ja)=(i, j)

(id, jd)=(i, 0)

3) When (i, j) is located in the region A, (i+720, j) is located in the region B, and (i, j+480) is located in the region A, i.e., ((960−720)<i<960 and j≦(540−480)), the regions C and D are not involved with screen combination. Therefore, SD-size sub-screens corresponding to the image processors 503 and 504 are not transferred. The transfer start positions of the SD-size sub-screens transferred to the regions A and B are:

(Pa, Qa)=(0, 0)

(Pb, Qb)=(960−i, 0)

The transfer image sizes are:

(960−i)×540 for SDa

(720−(960−i))×540 for SDb

The screen combination positions of the sub-screens in the regions A and B are:

(ia, ja)=(i, j)

(id, jd)=(0, j)

4) When (i, j) is located in the region A, (i+720, j) is located in the region A, and (i, j+480) is located in the region A, i.e., (i≦(960−720) and j (540−480)), the regions B, C, and D are not involved with screen combination. Therefore, SD-size sub-screens corresponding to the image processors 502, 503, and 504 are not transferred. The transfer start position of the SD-size sub-screen transferred to the region A is:

(Pa, Qa)=(0, 0)

The transfer image size is:

720×480 for SDa

The screen combination position of a sub-screen in the region A is:

(ia, ja)=(i, j)

5) When (i, j) is located in the region B and (i, j+480) is located in the region C, i.e., (960≦i, (540−480)<j<540), the regions A and D are not involved with screen combination. Therefore, SD-size sub-screens corresponding to the image processors 501 and 504 are not transferred. The transfer start positions of the SD-size sub-screens transferred to the regions B and C are:

(Pb, Qb)=(0, 0)

(Pc, Qc)=(0, 540−j)

The transfer image sizes are:

720×(540−j) for SDb

720×(480−(540−j)) for SDc

The screen combination positions of the sub-screens in the regions B and C are:

(ib, jb)=(i, j)

(ic, jc)=(i, 0)

6) When (i, j) is located in the region B and (i, j+480) is located in the region B, i.e., (i≦(960−720), j≦(540−480)), the regions A, C, and D are not involved with screen combination. Therefore, SD-size sub-screens corresponding to the image processors 501, 503, and 504 are not transferred. The transfer start position of the SD-size sub-screen transferred to the region B is:

(Pb, Qb)=(0, 0)

The transfer image size is:

720×480 for SDb

The screen combination position of a sub-screen in the region B is:

(ib, jb)=(i, j)

7) When (i, j) is located in the region D and (i+720, j) is located in the region C, i.e., ((960−720)<i≦960, 540≦j), the regions A and B are not involved with screen combination. Therefore, SD-size sub-screens corresponding to the image processors 501 and 502 are not transferred. The transfer start positions of the SD-size sub-screens transferred to the regions C and D are:

(Pc, Qc)=(0, 0)

(Pd, Qd)=(960−i, 0)

The transfer image sizes are:

(720−(960−i))×540 for SDc

(960−i)×540 for SDd

The screen combination positions of the sub-screens in the regions C and D are:

(ic, jc)=(0, j)

(id, jd)=(0, 0)

8) When (i, j) is located in the region D and (i+720, j) is located in the region D, i.e., (i (960−720), 540 j), the regions A, B, and C are not involved with screen combination. Therefore, SD-size sub-screens corresponding to the image processors 501, 502, and 503 are not transferred. The transfer start position of the SD-size sub-screen transferred to the region D is:

(Pd, Qd)=(0, 0)

The transfer image size is:

720×480 for SDd

The screen combination position of a sub-screen in the region D is:

(id, jd)=(i, j)

9) When (i, j) is located in the region C, i.e., (960≦i, 540≦j), the regions A, B, and D are not involved with screen combination. Therefore, SD-size sub-screens corresponding to the image processors 501, 502, and 504 are not transferred. The transfer start position of the SD-size sub-screen transferred to the region C is:

(Pc, Qc)=(0, 0)

The transfer image size is:

720×480 for SDc

The screen combination position of a sub-screen in the region C is:

(ic, jc)=(i, j)

When receiving the division data position, the transfer size, and the screen combination position of each of the HD-size video and the SD-size video, the image processors 501-504 each perform calculation using the overlapping region calculator 515, taking into consideration overlapping regions (α pixels, β lines) flanking division boundaries, set a data transfer size and a position corresponding to the result of the calculation into the data request generators 512 and 513, and set an image processing size into the resizing units 507 and 508 and the image quality improving image quality adjuster 510. Here, α and β are determined, depending on at least the number of taps in a process in the horizontal or vertical direction in the resizing units 507 and 508 and the image quality improving image quality adjuster 510 of each image processor.

The resizing units 507 and 508 enlarge the HD-size sub-video data from ((960+α) pixels, (540+β) lines) to (2×(960+α) pixels, 2×(540+β) lines), and also enlarges the SD-size sub-video data from (u pixels, v lines) to (2×(u+α) pixels, 2×(v+β) lines) where (u pixels, v lines) is the size of each sub-video data. Thereafter, the combiner 509 performs screen combination based on positions (2 in, 2jn) (n=a, b, c, and d). The image quality improving image quality adjuster 510 whose mode has been set by the image processing mode controller 506 performs image quality improving image processing with respect to the image containing the overlapping regions. In this case, lines and pixels removed by the trimming are those during vertical and horizontal blanking periods. Thereafter, the pieces of data of the four regions having the HD size enlarged by the image processors 501-504 in similar manners are combined into video having the 4K×2K size after the processing of the video processing system. In this case, the boundaries of the four regions are subjected to image processing using the overlapping regions without performing an end process, i.e., continuous video data is used. As a result, the PIP display of HD-size video and SD-size video can be achieved without disturbance occurring at the boundaries when the four regions are combined.

With the aforementioned configuration of the second embodiment, two pieces of video data are each divided into four pieces by performing calculation using the region division calculator 505 based on screen combination positions and combination screen sizes, and controlling transfer of the image processors 501-504, and the two-screen combination process is performed by each of the separate image processors 501-504. Therefore, when the resultant four screens are subsequently combined, disturbance does not occur at the boundaries.

The size of the decoded video data in the external memory in the second embodiment may be that of an interlaced material (1920×540) or 4K×2K in addition to the HD size (1920×1080) and the SD size (720×480).

The size of the decoded video data in the external memory in the second embodiment may be that of on-screen display (OSD) data in addition to that of video data.

The two-screen combination process of the second embodiment may be superimposition of on-screen display (OSD) data in addition to Picture in Picture (PIP).

While, in the second embodiment, video data is divided into four pieces and four image processors are provided, the present disclosure is not limited to four. The present disclosure may provide a system in which video data is divided into N pieces (N is an integer of two or more) and N image processors are provided.

### Third Embodiment

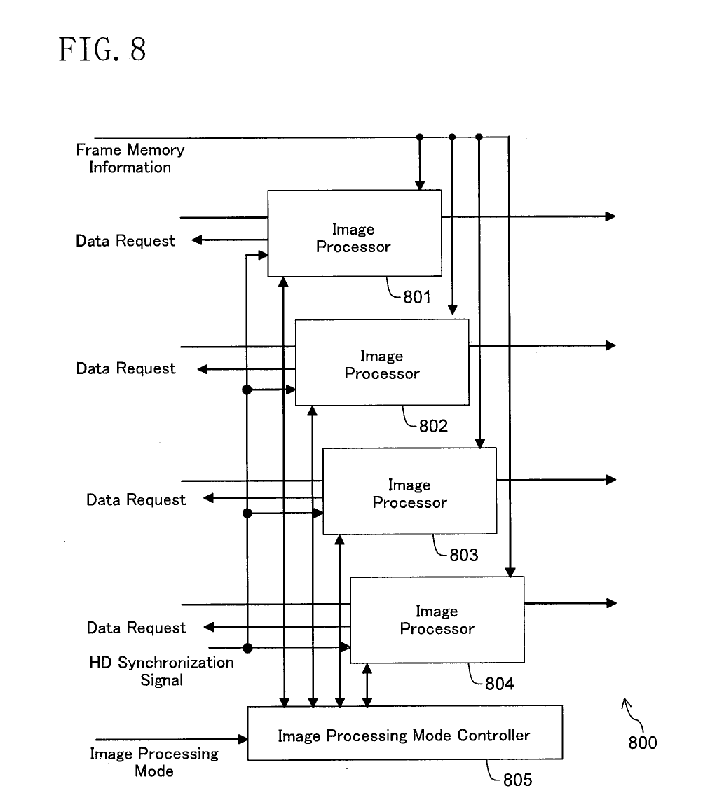

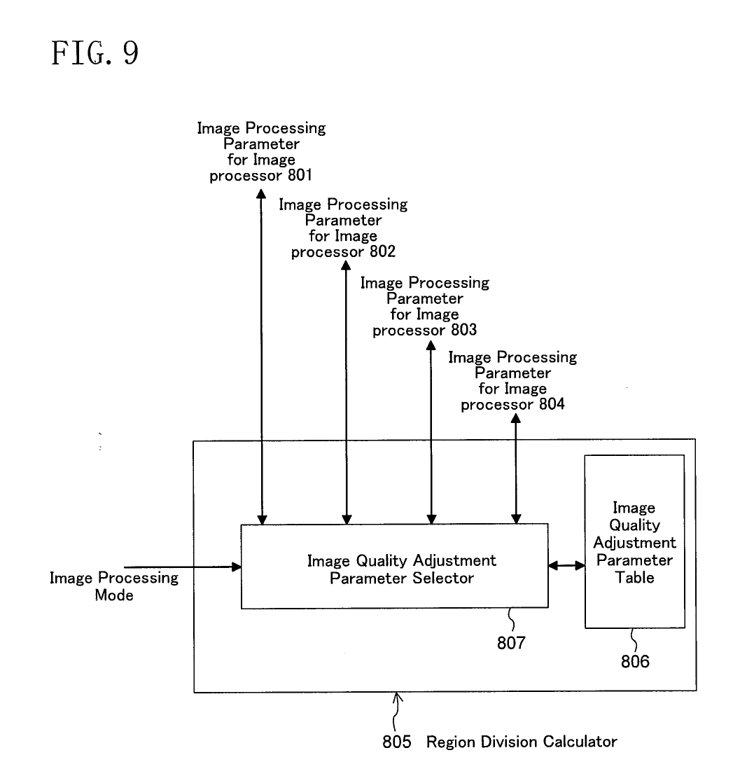

A third embodiment of the present disclosure will be described hereinafter with reference to FIGS. 8 and 9.

FIGS. 8 and 9 are diagrams showing a configuration of a video processing system according to the third embodiment of the present disclosure.

The configuration of the video processing system 800 of the third embodiment will be described with reference to FIG. 8, in which the high-definition (HD) resolution is increased to the 4K×2K resolution, and image quality adjustment can be executed and selected while the user compares favorite types of image quality adjustment. The video processing system 800 of the third embodiment includes four image processors 801-804 each of which is capable of processing HD-size video and is synchronous with an HD synchronization signal, and an image processing mode controller 805 which controls image processing modes of the image processors 801-804.

FIG. 9 shows a configuration of the image processing mode controller 805 of the third embodiment. The image processing mode controller 805 includes an image quality adjustment parameter table 806 which holds setting parameters of image quality adjustment of the image processors 801-804, and an image quality adjustment parameter selector 807 which generates an address which is used to extract a set value from the parameter table.

Operation of the video processing system thus configured will be described.

It is assumed that HD-size decoded video data from digital broadcasting, an HD-compliant disk, or the like is stored in an external memory, such as a dynamic random access memory (DRAM) or the like, four types of image quality adjustment are performed with respect to the video data so that the user selects a favorite image quality adjustment mode, the resultant HD-size images are combined into 4K×2K-size video after the processing of the video processing system. Initially, similar data transfer sizes, positions, and image processing sizes are set into the image processors 801-804 so that the same decoded HD video data in the external memory is transferred to the image processors 801-804.

In the image processing mode controller 805, in the normal mode, the image quality adjustment parameter selector 807 selects a corresponding address from the image quality adjustment parameter table 806, and sets the same image quality adjustment setting parameter as an image processing mode of the four image processors 801-804. In the third embodiment, when a mode in which the user can compare types of image quality adjustment is set into the image processing mode controller 805, the image quality adjustment parameter selector 807 generates addresses of the image quality adjustment parameter table 806 corresponding to four image quality adjustment modes to be compared by the user, and selects and extracts four image quality adjustment parameters from the image quality adjustment parameter table 806. The four image quality adjustment parameters are set into the respective image processors 801-804.

The four image processors 801-804 are controlled so that the same HD image data are input thereto. In this case, different image quality adjustment modes are set in the image quality improving image quality adjusters 108 (FIG. 2) of the four image processors 801-804, and therefore, the image processors 801-804 performs four types of image processing with respect to the same HD image data and outputs four pieces of HD image data. After the processing of the video processing system, the four pieces of HD-size image data are combined into 4K×2K-size video. As a result, the same HD image data is subjected to four types of image quality improving image quality adjustment, and the resultant four pieces of image data having the 4K×2K size which will constitute one frame are output.

With the aforementioned configuration of the third embodiment, the same HD image data is subjected to four types of image quality improving image quality adjustment, and the resultant four pieces of image data are output as a video frame having the 4K×2K resolution. As a result, the user can select a favorite image quality adjustment mode while comparing other image quality adjustment modes.

The image quality adjustment parameter table of the third embodiment may not be provided. Image quality adjustment parameters may be individually set.

While, in the third embodiment, video data is divided into four pieces and four image processors are provided, the present disclosure is not limited to four. The present disclosure may provide a system in which video data is divided into N pieces (N is an integer of two or more) and N image processors are provided.

### Fourth Embodiment

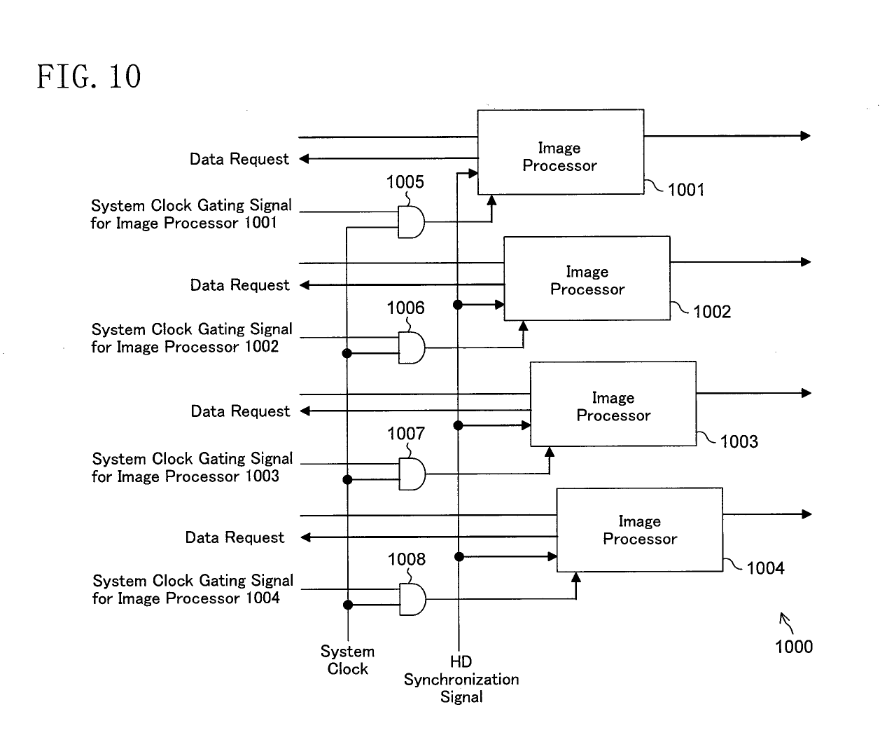

A fourth embodiment of the present disclosure will be described hereinafter with reference to FIG. 10.

FIG. 10 is a diagram showing a configuration of a video processing system according to the fourth embodiment of the present disclosure.

The configuration of the video processing system of the fourth embodiment will be described with reference to FIG. 10, which can increase the high definition (HD) resolution to the 4K×2K resolution, and is connected to a video display device in a succeeding stage which has the HD resolution rather than the 4K×2K resolution. The video processing system of the fourth embodiment includes four image processors 1001-1004 each of which is capable of processing HD-size video and is synchronous with an HD synchronization signal, and two-input AND circuits 1005-1008 which stop system clocks (operating clocks) with which the image processors 1001-1004 are separately operated. The AND circuits 1005-1008 each receive the corresponding system clock and a system clock gating signal dedicated to the corresponding image processor.

Operation of the video processing system thus configured will be described hereinafter.

It is assumed that HD-size decoded video data from digital broadcasting, an HD-compliant disk, or the like is stored in an external memory, such as a dynamic random access memory (DRAM) or the like, the video processing system increases the resolution of the video data to the 4K×2K resolution and outputs the video data having the 4K×2K resolution, and a video display device in a succeeding stage which is connected to the video processing system has the HD display resolution.

The image processors 1001-1004 which process HD-size images normally divides HD-size video data into four pieces of sub-video data and enlarge the sub-video data in order to output 4K×2K size video data, i.e., upconverts the HD video data into 4K×2K video data. However, when the video display device in the succeeding stage which is connected to video processing system has only the HD display resolution (e.g., the video display device is connected via an HDMI cable), the video processing system can recognize the maximum resolution of the video display device.

The video processing system, when recognizing that a video display device having the HD display resolution is connected to itself, stops the system clocks for three of the four image processors 1001-1004 using separate system clock gating signals. As a result, the 4K×2K video processing system can reduce power consumption to that for an HD system when outputting HD-size video.

With the aforementioned configuration of the fourth embodiment, when an HD-size video display device is connected to the 4K×2K video processing system, the 4K×2K video processing system can stop system clocks which are used to operate three of the four image processors 1001-1004 for processing 4K×2K images. As a result, the 4K×2K video processing system can reduce power consumption to that for an HD system when outputting HD-size video.

As described above, the present disclosure can process boundaries of sub-images without a degradation in image quality and is therefore useful for video processing systems.

1. A video processing system comprising:
N (N is an integer of two or more) image processors each configured to be capable of processing high definition (HD)-size video and be synchronous with an HD synchronization signal;
a region division calculator configured to control data transfer regions of the N image processors; and
an image processing mode controller configured to control image processing modes of the N image processors,
wherein
the N image processors process N respective pieces of sub-video data obtained by dividing video data, and the processed N pieces of sub-video data are combined in a succeeding stage from the N image processors.

2. The video processing system of claim 1, wherein
each of the N image processors includes
an overlapping region calculator configured to calculate an overlapping region at an image boundary between adjacent regions of the N pieces of sub-video data obtained by the region division calculator,
an active period generator configured to generate an active period of video data based on the result of the calculation of the overlapping region calculator,
a data request generator configured to request data transfer corresponding to the active period,
a resizing processor configured to resize boundary video data,
an image quality improving image quality adjuster configured so that a mode thereof is set by the image processing mode controller, and
an image trimmer configured to remove data of the overlapping region.

3. The video processing system of claim 2, wherein
the N image processors perform image processing with respect to the overlapping region during a blanking period of the HD synchronization signal.

4. The video processing system of claim 3, wherein
the image quality improving image quality adjuster has a mechanism configured to store a cumulative value of feature amounts or motion detection results of video, and
cumulative values of the sub-images are integrated and judged by the image processing mode controller, and the result of the judgment is used to set the mode of the image quality improving image quality adjuster again.

5. The video processing system of claim 3, wherein
each of the N image processors includes a combiner configured to combine a plurality of image planes, and
the region division calculator calculates division coordinates and size information of combination screens from screen combination coordinates, and sets the result of the calculation into the data request generators of the N image processors so that screen combination is performed with respect to the N pieces of sub-video data.

6. A video processing system comprising:
N (N is an integer of two or more) image processors each configured to be capable of processing high definition (HD)-size video and be synchronous with an HD synchronization signal; and
an image processing mode controller configured to control image processing modes of the N image processors,
wherein
the N image processors process the same video data, the image processing mode controller sets different image processing modes into the N image processors, and N screens are combined after image processing of the N image processors.

7. A video processing system comprising:
N (N is an integer of two or more) image processors each configured to be capable of processing high definition (HD)-size video and be synchronous with an HD synchronization signal,
wherein
operating clocks of the N image processors can be separately stopped.
